(19) United States
(12) Patent Application Publication
(10) Pub. No.: US 2025/0172909 A1
(43) Pub. Date: May 29, 2025

(54) Mechanical Watch

(71) Applicant: SEIKO EPSON CORPORATION, Tokyo (JP)

(72) Inventor: Keiichi MUKAIYAMA, Matsumoto (JP)

(21) Appl. No.: 18/961,744

(22) Filed: Nov. 27, 2024

(30) Foreign Application Priority Data
Nov. 29, 2023 (JP) 2023-201440

(51) Int. Cl. G04B 15/14; G04B 15/08

(52) U.S. Cl. CPC G04B 15/14; G04B 15/08

(57) ABSTRACT

A mechanical watch includes an escapement including a silicon-made escape wheel, and a configuration in which an hour hand, a minute hand, and a second hand are collected at one place. A ganging pin of an escape wheel and pinion including the escape wheel and a fourth winding pinion of a fourth wheel and pinion to which the second hand is attached are engaged. A shaft of the fourth wheel and pinion is applied a biasing force by an elastic member in an axial direction toward a side where the second hand is attached.

The present application is based on, and claims priority from JP Application Serial Number 2023-201440, filed Nov. 29, 2023, the disclosure of which is hereby incorporated by reference herein in its entirety.

### BACKGROUND

### 1. Technical Field

The present disclosure relates to a mechanical watch.

### 2. Related Art

For example, JP-A-2021-81299 discloses a mechanical watch including an escapement having a silicon-made escape wheel and having a configuration in which an hour hand, a minute hand, and a second hand are collected at one place.

However, in the mechanical watch of JP-A-2021-81299, when an impact such as a drop is applied, an impact force is transmitted to the escape wheel and pinion, and the impact force is transmitted to the second hand in a rotation direction at a timing different from a normal timing. A tip of the silicon-made escape wheel collides with a finger of the pallet fork, and the tip of the escape wheel is damaged.

### SUMMARY

According to an aspect of the present disclosure, a mechanical watch including an escapement including a silicon-made escape wheel, and a configuration in which three of an hour hand, a minute hand, and a second hand are collected at one place, in which a ganging pin of an escape wheel and pinion including the escape wheel and a fourth winding pinion of a fourth wheel and pinion to which the second hand is attached are engaged, and a shaft of the fourth wheel and pinion is applied a biasing force by an elastic member in an axial direction toward a side where the second hand is attached.

### BRIEF DESCRIPTION OF THE DRAWINGS

FIG. 1 is a front view of a mechanical watch according to a first embodiment.

FIG. 2 is a plan view of a front side of a movement of the mechanical watch according to the first embodiment.

FIG. 3 is a plan view of an escapement according to the first embodiment.

FIG. 4 is a perspective view showing a configuration of an escapement and a fourth wheel and pinion.

FIG. 5 is a sectional view showing a disposition relationship between the fourth wheel and pinion and an elastic member.

FIG. 6 is a sectional view showing a disposition relationship between a fourth wheel and pinion and an elastic member of a mechanical watch according to a second embodiment.

FIG. 7 is a plan view showing a pallet fork of a mechanical watch according to a third embodiment.

### DESCRIPTION OF EMBODIMENTS

### 1. First Embodiment

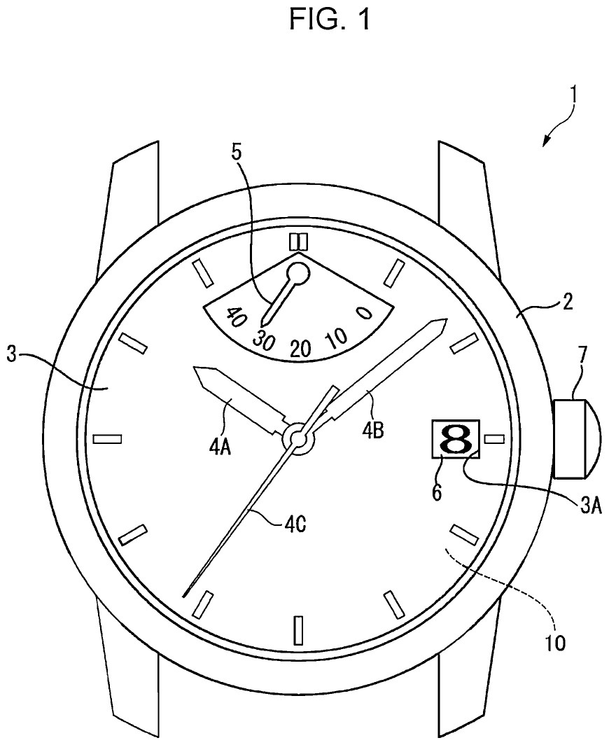

First, as a mechanical watch 1 according to a first embodiment, a clock including the escapement 80 including a silicon-made escape wheel 110 and having a configuration in which three of an hour hand 4A, a minute hand 4B, and a second hand 4C are collected at one place will be described with reference to FIGS. 1 to 5. In each of the following drawings, respective members may be shown with a scale different from the actual scale in order to make the members recognizable.

As shown in FIG. 1, the mechanical watch 1 of the present embodiment includes a cylindrical exterior case 2, and a disk-shaped dial 3 is disposed on an inner peripheral side of the exterior case 2. Among two openings of the exterior case 2, the opening on a front surface side is closed with a cover glass, and the opening on a back surface side is closed with a case back.

In addition, the mechanical watch 1 includes a movement 10 for a clock accommodated in the exterior case 2, the hour hand 4A, the minute hand 4B, and the second hand 4C that display time information, and a power reserve hand 5 that indicates a duration by a mainspring.

The hands such as the hour hand 4A, the minute hand 4B, the second hand 4C, and the power reserve hand 5 are attached to a hand shaft of the movement 10 and are driven by the movement 10.

The dial 3 is provided with a calendar small window 3A, and a date indicator 6 can be visually recognized from the calendar small window 3A.

A spout 7 is provided on a side surface of the exterior case 2. The spout 7 can be pulled by two stages from a 0-stage position, which is a normal position, toward a center of the mechanical watch 1.

When the spout 7 rotates at the 0-stage position, the mainspring can be wound up, as will be described later. The power reserve hand 5 moves in conjunction with the winding of the mainspring. The mechanical watch 1 of the present embodiment can secure a duration of substantially 40 hours when the mainspring is fully wound.

When the spout 7 is pulled to the first-stage position and rotated, the date can be matched by moving the date indicator 6. When the spout 7 is pulled to the two-stage position, the second hand 4C stops, and when the spout 7 is rotated at the two-stage position, the hour hand 4A and the minute hand 4B move and the time can be adjusted.

### 1.1 Movement

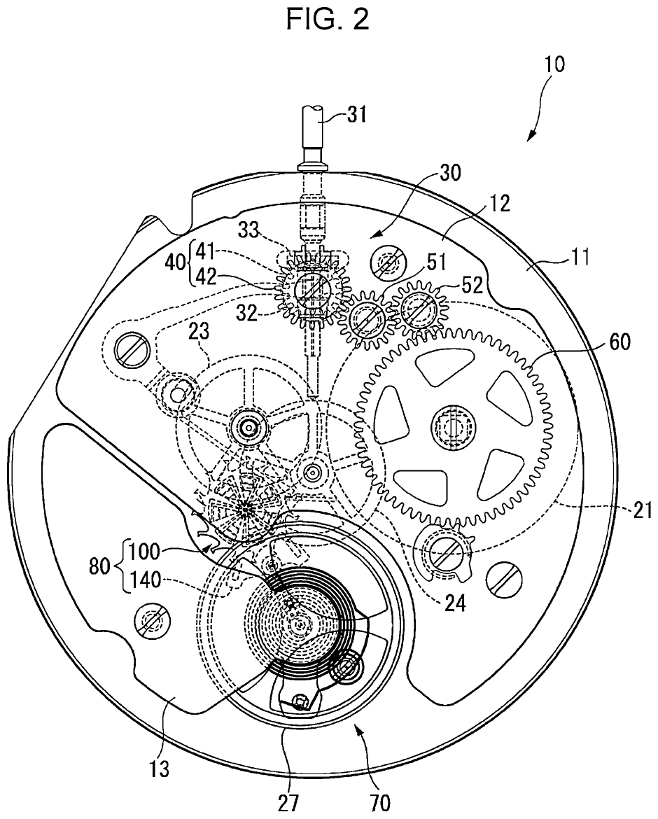

FIG. 2 is a plan view of a front side of the movement 10 of the mechanical watch 1. In FIG. 2, a front side of a paper surface, that is, a case back side of a main plate 11 is referred to as the front side, and a back side, that is, the cover glass side of the main plate 11 is referred to as the back side.

The movement 10 includes the main plate 11, a barrel and train wheel bridge 12, and a balance bridge 13. The dial 3 shown in FIG. 1 is disposed on the back side of the main plate 11. A rim row incorporated on the front side of the movement 10 is referred to as a front rim row, and a rim row incorporated on the back side of the movement 10 is referred to as a back rim row.

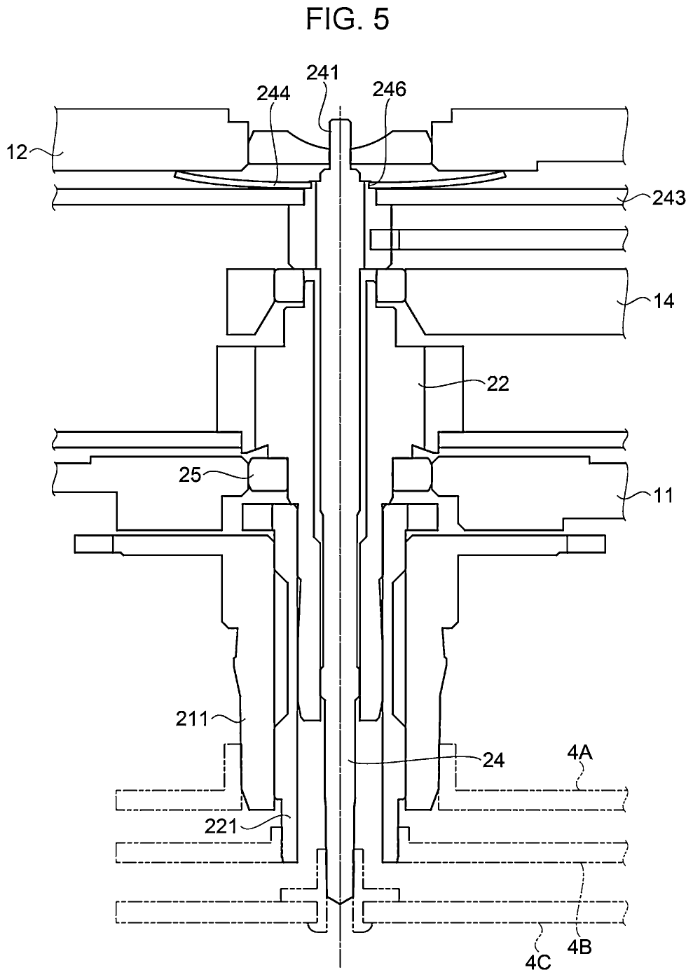

Between the main plate 11 and the barrel and train wheel bridge 12, a first wheel and pinion, which is a movement barrel complete 21, in which a mainspring is stored, a center wheel and pinion 22, a third wheel and pinion 23, a fourth wheel and pinion 24, and a fifth wheel and pinion, which is the escape wheel and pinion 100, as shown in FIG. 5, are disposed. In addition, between the main plate 11 and the balance bridge 13, the pallet fork 140, the balance with hairspring 27, and the like are disposed. The pallet fork 140 and the escape wheel and pinion 100 constitute the escapement 80, and the balance with hairspring 27 constitutes a speed controller 70.

### 1.2 Hand-Winding Mechanism

A hand winding mechanism 30 includes a winding stem 31, a winding wheel 32, a winding pinion 33, a crown wheel 40, a first intermediate wheel 51, and a second intermediate wheel 52, which are rotatably supported by the barrel and train wheel bridge 12, and transmits the rotation of the spout 7 by the rotation operation to the ratchet wheel 60, and rotates the ratchet wheel 60 and a fragrance box reel (not shown) to wind the mainspring. The crown wheel 40 is configured with a first crown wheel 41 that meshes with the winding pinion 33 and a second crown wheel 42 that rotates integrally with the first crown wheel 41 and meshes with the first intermediate wheel 51.

### 1.3 Speed Controller

The speed controller 70 causes the ring of the balance with hairspring 27 to repeatedly perform regular reciprocating rotation by the expansion and contraction of the constant force spring such as a clock mainspring.

### 1.4 Escapement

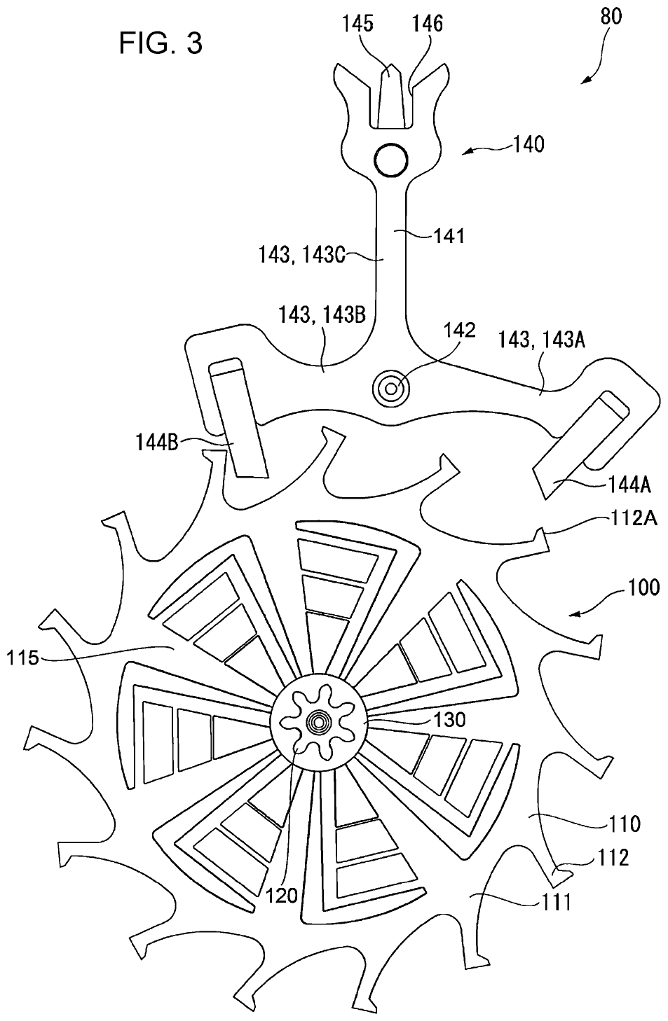

As shown in FIG. 3, the escapement 80 is configured to include the pallet fork 140 and the escape wheel and pinion 100 that constitutes the drive mechanism of the mechanical watch 1, and continuously applies a force for reciprocating with respect to the balance with hairspring 27 and controls the rim row with regular vibration of the balance with hairspring 27. A plurality of toothed portions 112 of the escape wheel and pinion 100 abuts against pallet stones 144A and 144B of the pallet fork 140.

The pallet fork 140 includes a pallet fork body 141 and a pallet fork shaft 142 that is a shaft. The pallet fork body 141 is formed in a T-shape by three pallet fork beams 143 of pallet fork arms 143A and 143B, and a pallet fork rod 143C, and is configured to be rotatable by the pallet fork shaft 142. The pallet fork shaft 142 is rotatably supported by the main plate 11 and a pallet bridge (not shown) at both ends thereof.

The pallet stones 144A and 144B are provided at distal ends of the pallet fork arms 143A and 143B which are two pallet fork beams 143 of the three pallet fork beams 143, and a sword tip 145 is attached to a distal end of the pallet fork rod 143C which is the remaining one pallet fork beam 143. In addition, the distal end of the pallet fork rod 143C is formed in a U shape in a plan view, and a space inside thereof is a pallet fork box 146. The pallet stones 144A and 144B are rubies formed in a quadrangular columnar shape, and are adhesively fixed to the pallet fork beam 143 by an adhesive or the like.

When the pallet fork 140 configured as described above rotates about the pallet fork shaft 142, the pallet stone 144A or the pallet stone 144B abuts against the abutting surface 112A of the toothed portion 112 of the escape wheel and pinion 100. At this time, the pallet fork rod 143C comes into contact with an embankment pin (not shown), and thereby the pallet fork 140 is prevented from rotating further in the same direction. As a result, the rotation of the escape wheel and pinion 100 is also temporarily stopped.

The escape wheel and pinion 100 has an insertion hole into which a ganging pin 120 is inserted at a central portion. The ganging pin 120 is inserted into the insertion hole and is pinched by a spacer 130 to be fixed to the ganging pin 120. The escape wheel 110 is held to be rotatable together with the ganging pin 120 around upper and lower tenons of the ganging pin 120.

The escape wheel and pinion 100 is configured of the escape wheel 110 including a rim portion 111 having a plurality of toothed portions 112 and a holding portion 115 holding the ganging pin 120. The rim portion 111 is an annular portion at an outer edge of the escape wheel and pinion 100. The toothed portion 112 is projected outward from an outer periphery of the rim portion 111 and is formed in a special hook shape. As shown in FIG. 3, the pallet stones 144A and 144B of the pallet fork 140 abut against the abutting surfaces 112A of the plurality of toothed portions 112.

The escape wheel 110 has a disk shape having a uniform thickness over the entire surface, and is made of silicon. The silicon-based material means that silicon is a main component. The type of silicon is not particularly limited, and an appropriate type can be selected from the viewpoint of processability. Examples of the silicon include single crystal silicon, polycrystalline silicon, and the like. These may be used alone or in combination of two or more.

The silicon-made escape wheel 110 can be manufactured by, for example, a photolithography technique or an etching technique, and can have excellent processing accuracy.

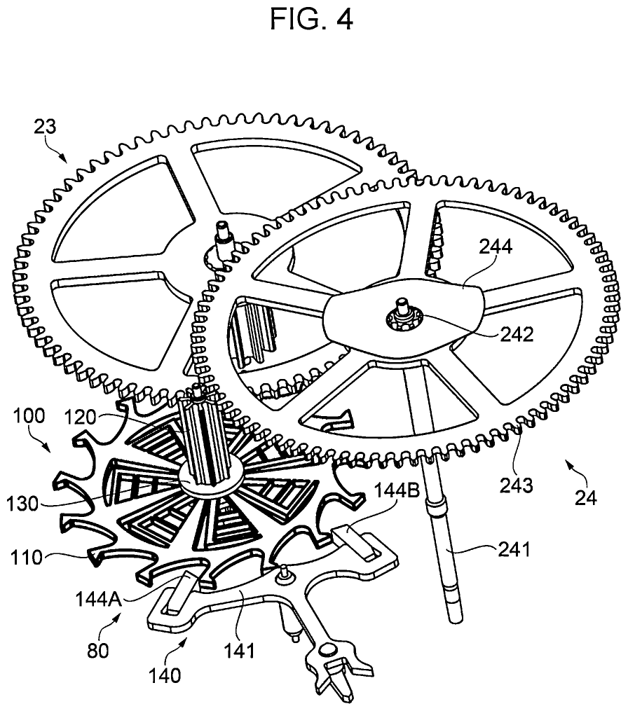

Next, a configuration of the escapement 80 and the fourth wheel and pinion 24 will be described with reference to FIG. 4.

As shown in FIG. 4, the fourth wheel and pinion 24 is configured with a shaft 241, a pin 242, and a fourth winding pinion 243, and the ganging pin 120 of the escape wheel and pinion 100 and the fourth winding pinion 243 of the fourth wheel and pinion 24 to which the second hand 4C is attached are engaged with each other. Therefore, when an impact such as a drop is applied, the impact force is transmitted to the escape wheel and pinion 100 via the fourth wheel and pinion 24, and the impact force is transmitted to the second hand 4C at a timing different from the normal timing. The toothed portion 112 of the silicon-made escape wheel 110 may collide with the pallet stones 144A and 144B of the pallet fork 140, and the distal end of the toothed portion 112 of the escape wheel 110 may be damaged. Therefore, in the present embodiment, the elastic member 244 is laid on the fourth winding pinion 243 of the fourth wheel and pinion 24 in order to prevent the distal end of the toothed portion 112 of the escape wheel 110 from being damaged by the impact force.

Next, a disposition relationship between the fourth wheel and pinion 24 and the elastic member 244 will be described with reference to FIG. 5. In the mechanical watch 1 of the present embodiment having a configuration in which the three of the hour hand 4A, the minute hand 4B, and the second hand 4C are collected at one place, as shown in FIG. 5, a cannon pinion 221 to which the minute hand 4B is attached is disposed inside an hour wheel 211 to which the hour hand 4A is attached, and the fourth wheel and pinion 24 to which the second hand 4C is attached is disposed inside the cannon pinion 221. In addition, the fourth winding pinion 243 and the elastic member 244 are disposed between the barrel and train wheel bridge 12 and the center wheel bridge 14, and the center wheel and pinion 22 is disposed between the center wheel bridge 14 and the main plate 11.

The elastic member 244 is a dial washer, and is laid on a step 246 provided in the middle of the shaft 241 of the fourth wheel and pinion 24. When the barrel and train wheel bridge 12 is fixed to the main plate 11, the elastic member 244 is deformed to generate a spring force, so that a biasing force can be applied in the axial direction toward the side where the second hand 4C is attached to the fourth wheel and pinion 24 via the step 246. Therefore, when the biasing force is applied in the axial direction, a friction load is generated between the elastic member 244 and the fourth wheel and pinion 24, or between the barrel and train wheel bridge 12 and the elastic member 244, and a hole jewel 25 installed between the fourth wheel and pinion 24 and the center wheel bridge 14. Therefore, even when the impact force is applied, the shaft 241 of the fourth wheel and pinion 24 is unlikely to move in the direction orthogonal to the axial direction. As a result, it is possible to prevent the impact force from being directly transmitted to the escape wheel and pinion 100.

As described above, in the mechanical watch 1 according to the present embodiment, the elastic member 244 is attached to the shaft 241 of the fourth wheel and pinion 24, so that the elastic member 244 imparts the biasing force in the axial direction toward the side where the second hand 4C is attached to the shaft 241 of the fourth wheel and pinion 24. Therefore, even when an impact such as a drop is applied, the shaft 241 of the fourth wheel and pinion 24 that is engaged with the escape wheel and pinion 100 is unlikely to move in the direction orthogonal to the axial direction. As a result, it is possible to prevent the impact force from being directly transmitted to the escape wheel and pinion 100, and it is possible to prevent the distal end of the toothed portion 112 of the escape wheel 110 from being damaged by the impact force.

### 2. Second Embodiment

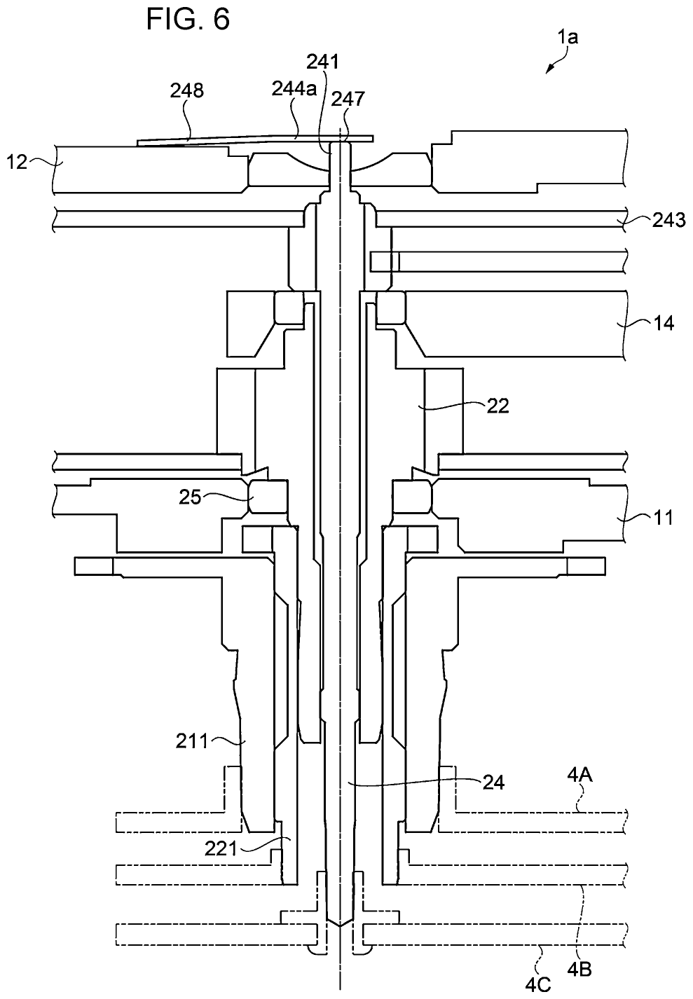

Next, a mechanical watch 1a according to a second embodiment will be described with reference to FIG. 6.

The mechanical watch 1a of the present embodiment is the same as the mechanical watch 1 of the first embodiment except that the structure and the disposition position of the elastic member 244a are different from those of the mechanical watch 1 of the first embodiment. The same matters as in the first embodiment will be designated by the same reference numerals and the description thereof will be omitted.

As shown in FIG. 6, the mechanical watch 1a is provided with the elastic member 244a laid on the surface opposite to the side where the fourth winding pinion 243 of the barrel and train wheel bridge 12 is disposed.

The elastic member 244a is a flat plate, one end portion of the elastic member 244a is laid on the end of the shaft 241 of the fourth wheel and pinion 24 on the side opposite to the axial direction in which the second hand 4C is attached, and the elastic member 244a is fixed to the barrel and train wheel bridge 12 by a fixing portion 248 provided in the other end portion of the elastic member 244a. The fixing method is a method such as screwing or press-fitting to a protrusion portion.

With such a configuration, the same effects as those obtained in the first embodiment can be obtained.

### 3. Third Embodiment

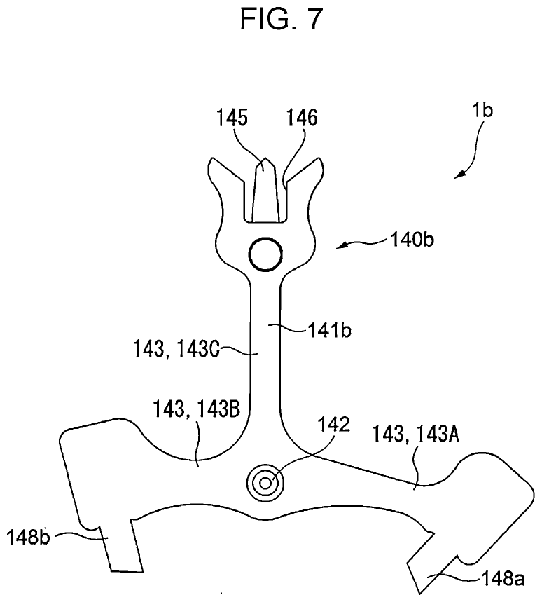

Next, a mechanical watch 1b according to a third embodiment will be described with reference to FIG. 7.

The mechanical watch 1b of the present embodiment is the same as the mechanical watch 1 of the first embodiment except that the configuration of the pallet fork 140b is different from that of the mechanical watch 1 of the first embodiment. The same matters as in the first embodiment will be designated by the same reference numerals and the description thereof will be omitted.

The mechanical watch 1b has the pallet fork 140b that is paired with the escape wheel and pinion 100 and is formed of silicon. More specifically, as shown in FIG. 7, the pallet fork body 141b and the pallet stones 148a and 148b are integrally formed of silicon. Therefore, in the step of assembling the pallet fork 140 of the first embodiment, the step of adhesively fixing the pallet stones 144A and 144B to the pallet fork body 141 can be omitted.

With such a configuration, the same effects as those obtained in the first embodiment can be obtained.

What is claimed is:

1. A mechanical watch comprising: an escapement including a silicon-made escape wheel, and a configuration in which an hour hand, a minute hand, and a second hand are collected at one place, wherein
a ganging pin of an escape wheel and pinion including the escape wheel and a fourth winding pinion of a fourth wheel and pinion to which the second hand is attached are engaged, and a shaft of the fourth wheel and pinion is applied a biasing force by an elastic member in an axial direction toward a side where the second hand is attached.

2. The mechanical watch according to claim 1, wherein
the elastic member is a dial washer and is laid on a step provided in the middle of the shaft of the fourth wheel and pinion.

3. The mechanical watch according to claim 1, wherein
the elastic member is a flat plate, and is laid at an end portion of the shaft of the fourth wheel and pinion on a side opposite to the axial direction in which the second hand is attached.

4. The mechanical watch according to claim 2, wherein
a pallet fork that is paired with the escape wheel and pinion is formed of silicon.
